(19) United States
(12) Patent Application Publication
(10) Pub. No.: US 2008/0227643 A1
(43) Pub. Date: Sep. 18, 2008

(54) Use of adjuvants to improve abscisic acid analog and abscisic acid derivative performance

(76) Inventors: Xiaozhong Liu, Vernon Hills, IL (US); Daniel F. Heiman, Libertyville, IL (US); Derek D. Woolard, Zion, IL (US); Rick Hopkins, Fresno, CA (US); Yueh Wang, Arlington Heights, IL (US); Benjamin Belkind, Wilmette, IL (US); Prem Warrior, Green Oaks, IL (US); Gregory D. Venburg, Deerfield, IL (US); Peter D. Petracek, Grayslake, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/011,863

(22) Filed: Jan. 30, 2008

Related U.S. Application Data
(60) Provisional application No. 60/898,477, filed on Jan. 31, 2007.
(60) Provisional application No. 60/898,457, filed on Jan. 31, 2007.
(60) Provisional application No. 60/898,633, filed on Jan. 31, 2007.
(60) Provisional application No. 60/898,530, filed on Jan. 31, 2007.
(60) Provisional application No. 60/898,534, filed on Jan. 31, 2007.

(51) Int. Cl. A01N 37/06; A01P 21/00

(52) U.S. Cl. 504/320

(57) ABSTRACT

This invention relates to the use of adjuvants and nitrogen containing fertilizers to improve the performance of S-(+)-abscisic acid (S-ABA, ABA) analogs and ABA derivatives on tomato leaf transpiration inhibition.

### FIELD OF THE INVENTION

The present invention relates to the use of selected surfactants or nitrogen containing fertilizers to improve the performance of abscisic acid (ABA) analogs or ABA derivatives or their salts by increasing the extent and/or extending the duration of plant leaf transpiration inhibition.

### BACKGROUND OF THE INVENTION

Abscisic acid (ABA) is a natural occurring hormone found in all higher plants (Cutler and Krochko 1999, Trends in Plant Science, 4:472-478; Finkelstein and Rock 2002, The Arabidopsis Book, ASPB, Monona, MD, 1-52). ABA is involved in many major processes during plant growth and development including dormancy, germination, bud break, flowering, fruit set, general growth and development, stress tolerance, ripening, maturation, organ abscission, and senescence. ABA also plays an important role in plant tolerance to environmental stresses, such as drought, cold, and excessive salinity.

One key role of ABA in regulating physiological responses of plants is to act as a signal of reduced water availability to reduce water loss, inhibit growth and induce adaptive responses. All these functions are related to stomatal closure (Raschke and Hedrich 1985, Planta, 163: 105-118). When stomata close, plants conserve water to survive environmental stresses. However, stomatal closure also can results in the reduced photosynthesis, respiration and growth. Stomatal closure is a rapid response of plants to ABA. The mechanism of this effect has been studied and has been shown to be due primarily to ABA effects on guard cell ion channels. Specifically, ABA blocks H⁺ extrusion and K⁺ influx from guard cells and promotes K⁺, Cl⁻, and malate extrusion and Ca²⁺ influx. The net effect of ABA is to reduce the total osmotica in the guard cells, which in turn decreases the water content in the cell. This causes the guard cells to lose turgor and thus close the stomata (Assmann 2004, In: Plant Hormones Biosynthesis, Signal Transduction, Action, ed. Davies, p 391-412). The closing of the stomata results in reduced transpiration. The reduction of transpiration caused by stomatal closure is widely used as an experimental technique to indirectly identify and quantify ABA activity. The ability of ABA to reduce water use can not only extend the display shelf life of ornamentals or the postharvest shelf life of leafy plants, or promote drought tolerance, but it also can lead to a reduction in cold stress injury (Aroca et al. 2003, Plant Sci., 165: 671-679). ABA-induced reduction of stomatal conductance can lead to a decrease in photosynthesis (Downton et al. 1988 New Phytol., 108: 263-266) which in turn can lead to growth control. Improving the performance of ABA may be useful not only for improving the reduction of transpiration and water loss, but also for other uses of foliar applied ABA such as maintaining dormancy of buds and seeds, improving thinning, accelerating defoliation, and enhancing color development of fruit such as grape.

The exogenous application of ABA is an alternative approach to induce plant response to abiotic stress. However, exogenous ABA entering plant cells can be easily catabolized and, thus the effect of ABA on plants usually lasted a short time.

ABA analogs are chemicals with similar structures as natural ABA. A series of ABA analogs have been developed by the Plant Biology Institute of Canada to mimic ABA function. So far, many ABA analogs have reportedly exhibited ABA-like effects. Compared to natural ABA, ABA analogs are more resistant to degradation. However, the effects of ABA analog treatments vary with the concentration, mode of application (foliar or root-dip), and crop species.

Surfactants or adjuvants have long been used with pesticides and plant growth regulators to increase the absorption or uptake by plants and thus improve the performance of the applied chemicals. Adjuvants include wetter-spreaders, stickers, penetrants, compatibility agents, and fertilizers. Many adjuvants are currently available and most of them are nonionic surfactants. However, there is little information about adjuvants suitable for ABA analogs. Tween 20, a popular surfactant used scientific research, was reported to be added as the surfactant for ABA analogs (Waterer, 2000. ADF Project 97000289). However, Tween 20 is used for academic research and not packaged and distributed for the agricultural market.

Foliar applied nitrogen fertilizers, such as urea or ammonium nitrate, have been used in combination with plant growth regulators (PGRs) to improve the performance of the PGR. For example, the combination of the PGRs benzyladenine (Naito et al. 1974, J. Japan. Soc. Hort. Sci., 43: 215-223) or gibberellic acid (Shulman et al. 1987, Plant Growth Regul., 5: 229-234) with urea increased the grape berry sizing effect compared to the sizing effect achieved with the PGR alone. Ammonium salts have been reported to increase the absorption of pesticides (Wang and Liu 2007, Pestic. Biochem., Physiol., 87: 1-8). However, there is no prior art report of the use of urea (H₂NCONH₂) or ammonium nitrate (NH₄NO₃) to improve ABA analog performance.

In order maximize the performance of ABA in its various agricultural and horticultural applications; there is a need to improve ABA analog and ABA derivative absorption to reduce water loss and leaf transpiration of plants.

### SUMMARY OF INVENTION

The present invention is directed toward the incorporation of an effective amount of an adjuvant into an ABA analog-containing end-use solution composition or into a liquid or solid formulation composition intended for preparation of such an end-use solution in order to increase the effectiveness of ABA analogs by increasing the extent and/or extending the duration of their desired biological activity. This is accomplished by applying said end-use solution composition directly to target plants or the locus thereof by spraying or drenching.

The present invention is also directed to the incorporation of an effective amount of at least one adjuvant selected from the group consisting of polyoxyethylene fatty alcohol ethers, nonylphenol ethoxylates, polyalkylene oxides and blends of polyether-polymethylsiloxane copolymers and nonionic surfactants into an ABA analog-containing end-use solution composition in order to decrease the ABA analog application rate required to attain a targeted degree or duration of ABA biological activity.

The presently preferred polyoxyethylene fatty alcohol ether surfactant is Brij 98 (polyoxyethylene (20) oleyl ether).

The presently preferred nonylphenol ethoxylate is Agral 90.

The presently preferred polyalkylene oxides are Silwet L-77 (minimum 80% w/w polyalkylene oxide modified heptamethyltrisiloxane and a maximum of 20% w/w allyloxypolyethylene glycol methyl ether) and Kinetic (proprietary blend of polyalkyleneoxide modified polydimethylsiloxane and nonionic surfactant).

The presently preferred blend of Polyether-polymethylsiloxanecopolymer and nonionic surfactant is Capsil.

Presently preferred ABA analogs and derivatives include PBI-429 (8′ acetylene-ABA methyl ester) and PBI-524 (8′ acetylene-ABA, acid).

### DETAILED DESCRIPTION OF THE INVENTION

The compositions of the present invention improve ABA analog effectiveness by incorporating a surfactant, optionally a nitrogen-containing fertilizer together with an effective amount of the analog or derivative of plant growth regulator abscisic acid.

Presently preferred ABA analogs and derivatives include PBI-429, PBI-524, PBI-696 and PBI-702.

For the purposes of this Application, abscisic acid analogs are defined by Structures 1, 2 and 3, wherein for Structure 1:

the bond at the 2-position of the side chain is a cis- or trans-double bond,

the bond at the 4-position of the side chain is a trans-double bond or a triple bond,

the stereochemistry of the alcoholic hydroxyl group is S—, R— or an R,S— mixture,

the stereochemistry of the R1 group is in a cis-relationship to the alcoholic hydroxyl group,

R1=ethynyl, ethenyl, cyclopropyl or trifluoromethyl, and
R2=hydrogen or lower alkyl

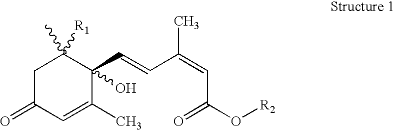

wherein lower alkyl is defined as an alkyl group containing 1 to 4 carbon atoms in a straight or branched chain, which may comprise zero or one ring or double bond when 3 or more carbon atoms are present.

For PBI-429, R1 is ethynyl and R2 is a methyl group.

For PBI-524, R1 is ethynyl and R2 is a hydrogen.

For PBI-696, R1 is cyclopropyl and R2 is a methyl group.

### For Structure 2:

the bond at the 2-position of the side chain is a cis- or trans-double bond,

the bond at the 4-position of the side chain is a triple bond,

the stereochemistry of the alcoholic hydroxyl group is S—, R— or an R,S— mixture,

R1=hydrogen or lower alkyl

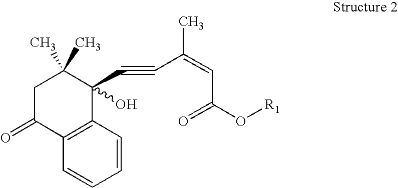

wherein lower alkyl is defined as an alkyl group containing 1 to 4 carbon atoms in a straight or branched chain, which may comprise zero or one ring or double bond when 3 or more carbon atoms are present.

For PBI-702, R1 is a methyl group.

### For Structure 3:

the bond at the 2-position of the side chain is a cis- or trans-double bond,

the bond at the 4-position of the side chain is a trans-double bond,

the stereochemistry of the alcoholic hydroxyl group is S—, R— or an R,S— mixture,

R1=hydrogen or lower alkyl

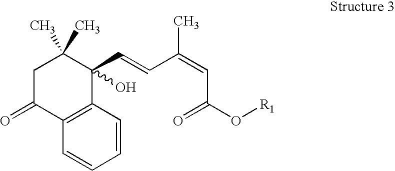

wherein lower alkyl is defined as an alkyl group containing 1 to 4 carbon atoms in a straight or branched chain, which may comprise zero or one ring or double bond when 3 or more carbon atoms are present.

ABA analog effectiveness may be measured experimentally by quantifying the inhibition of transpiration in tomato leaves; this is a reliable laboratory bioassay of the level of ABA activity.

The compositions of the present invention comprise an ABA analog together with an adjuvant or several adjuvants, and may be used to form a ready-to-apply liquid solution, a mixture prepared by the end user of the ABA analog or a solid or liquid formulation concentrate. The effectiveness of the compositions of the present invention was demonstrated by tomato leaf transpiration inhibition. The response of tomato plants to ABA analogs is representative of the response of other plant species, such as nursery plants, to ABA analogs. Other physiological processes regulated by ABA analogs such as the promotion of drought tolerance of bedding plants, fruit coloration, dormancy of buds and seeds, plant growth control, defoliation, and chilling and freeze stress protection are expected to respond to the combinations of ABA analogs with adjuvants of this invention.

The presently preferred surfactants for incorporation into the ABA compositions of the present invention members of the Brij family (polyoxyethylene fatty alcohol ethers), available from Uniqema (Castle, Del.). The presently most preferred surfactants for incorporation into the ABA compositions of the present invention are Brij 98 (polyoxyethylene (20) oleyl ether),

Agral 90 (Nonylphenol ethoxylate) available from Norac Concept. Inc. (Orleans, Ontario, Canada),
Silwet L-77 (minimum 80% w/w Polyalkylene oxide modified Heptamethyltrisiloxane and a maximum of 20% w/w allyloxypolyethylene glycol methyl ether) available from GE Silicones (Wilton, Conn.),
Kinetic (proprietary blend of polyalkyleneoxide modified polydimethylsiloxane and nonionic surfactant) available from Setre Chemical Company (Memphis, Tenn.) and
Capsil (Blend of Polyether-polymethylsiloxanecopolymer and nonionic surfactant) available from Aquatrols (Paulsboro, N.J.).

As used herein, the term “salt” refers to the water soluble salts of ABA or ABA analogs or derivatives, as appropriate. Representative such salts include inorganic salts such as the ammonium, lithium, sodium, potassium, calcium and magnesium salts and organic amine salts such as the triethanolamine, dimethylethanolamine and ethanolamine salts.

Depending on the target plant species, physiological processes of interest, and environmental conditions, the effective concentration of ABA analog can vary, but it is generally in the range of about 0.1 ppm to 10.00 ppm, and preferably from 1 to 100 ppm.

The preferred concentration of nonionic surfactant and/or anionic wetting agent surfactant in the end-use solutions of the present invention is 0.001% to 25% w/v, preferably from 0.01% to 5.0%.

The preferred concentration of nitrogen-containing fertilizer in the end-use solutions of the present invention is generally in the range about 0.1 mM to 1000 mM, preferably from 1 to 100 mM. Water is the carrier solvent in the end-use solutions.

Thus, a presently preferred composition of the present invention comprises from about 0.1 ppm to about 10,000 ppm ABA analog, from about 0.05 to about 5.0 weight % of a surfactant, with the balance of the composition consisting of water.

The effective concentration range of ABA analog depends on the water volume applied to plants as well as other factors such the plant age and size, the plant species and varietal sensitivity to ABA analog, and the targeted physiological process.

The invention is illustrated by, but is not limited by, the following representative examples.

### EXAMPLES

All the research studies were conducted in the greenhouse at the research farm of Valent BioSciences Corporation (Long Grove, Ill.). Tomato (variety: Rutgers) seeds were sown in 18-cell flats filled with Promix PGX (available from Premier Horticulture Inc. Quakertown, Pa.) three weeks for germination and initial growth. Plants were then transplanted into pots (18 cm in diameter and 18 cm in height) filled with Promix BX (available from Premier Horticulture Inc. Quakertown, Pa.) and grown for one or two more weeks before treatment, depending on greenhouse temperature. During growing periods, plants received daily irrigation and weekly fertilizer (1 g/L all purpose fertilizer 20-20-20, The Scotts Company, Marysville, Ohio).

Chemical solutions were prepared with distilled water. ABA analogs, 8′ acetylene-ABA, acid (PBI-524) and 8′ acetylene-ABA methyl ester (PBI-429) were available from Plant Biotechnology Institute, National Research Council of Canada (Saskatoon, Saskatchewan, Canada). 25 ppm PBI-429 or 25 ppm PBI-524 was prepared by dissolving 25 mg chemical in 1 L distilled water.

Tween 20 and Brij 98 were available from Uniqema (New Castle, Del.). Silwet L-77 was available from GE Silicones (Wilton, Conn.). Agral 90 was available from Norac Concept. Inc. (Orleans, Ontario, Canada). Kinetic was available from Setre Chemical Company (Memphis, Tenn.). Capsil was available from Aquatrols (Paulsboro, N.J.). Urea and ammonium nitrate (NH₄NO₃) were available from Sigma-Aldrich (St. Louis, Mo.). Ethyl lactate was available from Fluka Chemie (GmbH, Buchs, Germany). Surfactant was added to 250-ppm ABA or 25-ppm ABA analogs at the concentration of 0.05% or 0.5% (v/v). Since Brij 98 was a waxy substance and difficult to dissolve in water, a stock solution of 25% Brij 98 was prepared by dissolving 25 g Brij 98 in 75 g ethyl lactate and this solution was easily dissolve in water.

Chemical solutions were foliar applied to tomato plant leaves at the rate of 20 mL/6 plants. Plants were then placed in a transparent chamber with humidity controlled at relative humidity 40 to 60%. Leaf transpiration rate was measured 1, 2 and 3 days after treatment using a LI-1600 Steady State Porometer (LI-Cor, Lincoln, Nebr.). The transpiration rate of each treatment was calculated as the percentage of that of control at each day to reduce day-to-day variation caused by changes of environmental condition such as light intensity and temperature.

All experiments were randomized complete block experimental design. Data were analyzed by analysis of variance. Duncan's new multiple range tests at α=0.05 were used for mean separations.

### Example 1

Tomato leaf transpiration rate as affected by 25 ppm PBI-429 alone or its combination with 0.05% Brij 98 was examined (Table 1). Leaf transpiration of plants treated with PBI-429 alone decreased to the lowest of 77.52% of control at 4 days after treatment and an average of 89.66% of control over 7 days. Leaf transpiration of plants treated with PBI-429 with 0.05% Brij 98 decreased to the lowest of 59.14% of control at 3 days after treatment and an average of 74.01% of control over 7 days. Results indicated that Brij 98 improved PBI-429 performance on leaf transpiration inhibition.

TABLE 1
Effect of Brij 98 on improving PBI-429 performance for tomato leaf
transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-429 | 102 | 87 | 86 | 78 | 95 | 90 |
| 25 ppm PBI-429 + 0.05% | 90 | 67 | 59 | 66 | 89 | 74 |
| Brij 98 | | | | | | |

### Example 2

Leaf transpiration rate as affected by 25 ppm PBI-524 alone or its combination with 0.05% Brij 98 was examined (Table 2). Leaf transpiration of plants treated with PBI-524 alone decreased to the lowest of 87% of control at 4 days after treatment and an average of 94% of control over 7 days. Leaf transpiration of plants treated with PBI-524 with 0.05% Brij 98 decreased to the lowest of 38% of control at 2 days after treatment and an average of 61% of control over 7 days. Results indicated that Brij 98 improved PBI-524 performance on leaf transpiration inhibition.

TABLE 2
Effect of Brij 98 on improving PBI-524 performance for tomato leaf
transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-524 | 95 | 87 | 93 | 92 | 101 | 94 |
| 25 ppm PBI-524 + 0.05% | 65 | 38 | 54 | 60 | 89 | 61 |
| Brij 98 | | | | | | |

### Example 3

Brij 98 (0.05%) was compared to Tween 20 (0.05%) on improving 25 ppm PBI-429 and 25-ppm PBI-524 performance for tomato leaf transpiration inhibition (Table 3). Both Tween 20 and Brij 98 improved the performance of PBI-429 or PBI-524 on transpiration inhibition. The mixture of 0.05% Brij 98 and 25 ppm PBI-429 inhibited more transpiration than the mixture of 0.05% Tween 20 and 25 ppm PBI-429 on each tested date. The mixture of 0.05% Brij 98 and 25 ppm PBI-524 also inhibited more transpiration than the mixture of 0.05% Tween 20 and 25 ppm PBI-524. Results indicated that Brij 98 was much more efficient than Tween 20 in improving PBI-429 or PBI-524 performance on leaf transpiration inhibition.

TABLE 3
Comparison of Brij 98 with Tween 20 on improving PBI-429
and PBI-524 performance for tomato leaf transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-429 | 81 | 64 | 69 | 81 | 73 | 74 |
| 25 ppm PBI-429 + 0.05% | 45 | 43 | 47 | 47 | 64 | 49 |
| Tween 20 | | | | | | |
| 25 ppm PBI-429 + 0.05% | 32 | 23 | 35 | 39 | 52 | 36 |
| Brij 98 | | | | | | |
| 25 ppm PBI-524 | 81 | 63 | 69 | 79 | 91 | 77 |
| 25 ppm PBI-524 + 0.05% | 59 | 49 | 52 | 53 | 72 | 57 |
| Tween 20 | | | | | | |
| 25 ppm PBI-524 + 0.05% | 35 | 32 | 39 | 42 | 66 | 43 |
| Brij 98 | | | | | | |

### Example 4

Tomato leaf transpiration rate as affected by 25 ppm PBI-429 alone or its combination with 0.05% Agral 90 was examined (Table 4). Leaf transpiration of plants treated with PBI-429 alone decreased to the lowest of 78% of control at 4 days after treatment and an average of 90% of control over 7 days. Leaf transpiration of plants treated with PBI-429 with 0.05% Agral 90 decreased to the lowest of 64.15% of control at 2 days after treatment and an average of 79% of control over 7 days. Results indicated that Agral 90 improved PBI-429 performance on leaf transpiration inhibition.

TABLE 4
Effect of Agral 90 on improving PBI-429 performance for
tomato leaf transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-429 | 102 | 87 | 86 | 77 | 95 | 90 |
| 25 ppm PBI-429 + 0.05% | 98 | 64 | 67 | 72 | 93 | 79 |
| Agral 90 | | | | | | |

### Example 5

Leaf transpiration rate as affected by 25 ppm PBI-524 alone or its combination with 0.05% Agral 90 was examined (Table 5). Leaf transpiration of plants treated with PBI-524 alone decreased to the lowest of 87% of control at 4 days after treatment and an average of 94% of control over 7 days. Leaf transpiration of plants treated with PBI-524 with 0.05% Agral 90 decreased to the lowest of 70% of control at 2 days after treatment and an average of 86% of control over 7 days. Results indicated that Agral 90 improved PBI-524 performance on leaf transpiration inhibition.

TABLE 5
Effect of Agral 90 on improving PBI-524 performance for
tomato leaf transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-524 | 95 | 87 | 93 | 92 | 101 | 94 |
| 25 ppm PBI-524 + 0.05% | 90 | 70 | 84 | 89 | 96 | 86 |
| Agral 90 | | | | | | |

### Example 6

Tomato leaf transpiration rate as affected by 25 ppm PBI-429 alone or its combination with 0.05% Silwet L-77 or 0.05% Kinetic was examined (Table 6). Leaf transpiration of plants treated with PBI-429 alone decreased to the lowest of 78% of control at 4 days after treatment and an average of 90% of control over 7 days. Leaf transpiration of plants treated with PBI-429 with 0.05% Silwet L-77 decreased to the lowest of 57% of control at 3 days after treatment and an average of 73% of control over 7 days. Leaf transpiration of plants treated with PBI-429 with 0.05% Kinetic decreased to the lowest of 77% of control at 4 days after treatment and an average of 84% of control over 7 days. Results indicated that both Silwet L-77 and Kinetic improved PBI-429 performance on leaf transpiration inhibition.

TABLE 6
Effect of Silwet L-77 and Kinetic on improving PBI-429
performance for tomato leaf transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-429 | 102 | 87 | 86 | 78 | 95 | 90 |
| 25 ppm PBI-429 + 0.05% | 87 | 71 | 57 | 63 | 85 | 73 |
| Silwet L-77 | | | | | | |
| 25 ppm PBI-429 + 0.05% | 88 | 87 | 79 | 77 | 87 | 84 |
| Kinetic | | | | | | |

### Example 7

Leaf transpiration rate as affected by 25 ppm PBI-524 alone or its combination with 0.05% Silwet L-77 or 0.05% Kinetic was examined (Table 7). Leaf transpiration of plants treated with PBI-524 alone decreased to the lowest of 87% of control at 4 days after treatment and an average of 94% of control over 7 days. Leaf transpiration of plants treated with PBI-524 with 0.05% Silwet L-77 decreased to the lowest of 62% of control at 2 days after treatment and an average of 79% of control over 7 days. Leaf transpiration of plants treated with PBI-524 with 0.05% Kinetic decreased to the lowest of 62% of control at 2 days after treatment and an average of 79% of control over 7 days. Results indicated that Silwet L-77 and Kinetic improved PBI-524 performance on leaf transpiration inhibition.

TABLE 7
Effect of Silwet L-77 and Kinetic on improving PBI-524
performance for tomato leaf transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-524 | 95 | 87 | 93 | 92 | 101 | 94 |
| 25 ppm PBI-524 + 0.05% | 85 | 69 | 81 | 76 | 97 | 82 |
| Silwet L-77 | | | | | | |
| 25 ppm PBI-524 + 0.05% | 84 | 62 | 78 | 80 | 93 | 79 |
| Kinetic | | | | | | |

### Example 8

Tomato leaf transpiration rate as affected by 25 ppm PBI-429 alone or its combination with 0.05% Capsil was examined (Table 8). Leaf transpiration of plants treated with PBI-429 alone decreased to the lowest of 78% of control at 4 days after treatment and an average of 90% of control over 7 days. Leaf transpiration of plants treated with PBI-429 with 0.05% Capsil decreased to the lowest of 71% of control at 4 days after treatment and an average of 86% of control over 7 days. Results indicated that Capsil improved PBI-429 performance on leaf transpiration inhibition.

TABLE 8
Effect of Capsil on improving PBI-429 performance
for tomato leaf transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-429 | 102 | 87 | 86 | 78 | 95 | 90 |
| 25 ppm PBI-429 + 0.05% | 107 | 81 | 78 | 71 | 93 | 86 |
| Capsil | | | | | | |

### Example 9

Leaf transpiration rate as affected by 25 ppm PBI-524 alone or its combination with 0.05% Capsil was examined (Table 9). Leaf transpiration of plants treated with PBI-524 alone decreased to the lowest of 87% of control at 4 days after treatment and an average of 94% of control over 7 days. Leaf transpiration of plants treated with PBI-524 with 0.05% Capsil decreased to the lowest of 65% of control at 2 days after treatment and an average of 82% of control over 7 days. Results indicated that Capsil improved PBI-524 performance on leaf transpiration inhibition.

TABLE 9
Effect of Capsil on improving PBI-524 performance
for tomato leaf transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-524 | 95 | 87 | 93 | 92 | 101 | 94 |
| 25 ppm PBI-524 + 0.05% | 74 | 65 | 84 | 79 | 97 | 82 |
| Capsil | | | | | | |

### Example 10

The effect of Capsil on improving ABA analog performance for leaf transpiration inhibition was compared between PBI-429 and PBI-524 (Table 10). Leaf transpiration rate of plants treated with PBI-429 alone was similar to with PBI-524 alone at each tested day as well as the average over 7 days. Leaf transpiration of plants treated with PBI-429 with 0.05% Capsil was lower than treated with PBI-524 with 0.05% Capsil at each tested day as well as the average over 7 days. Results indicated Capsil was more effective in improving PBI-429 performance than PBI-524 performance for transpiration inhibition.

TABLE 10
Effect of Capsil on improving PBI-429 and PBI-524
performance for tomato leaf transpiration inhibition.

| | Transpiration rate (% of control) | | | | | |
|---|---|---|---|---|---|---|
| | Days after treatment | | | | | |
| Treatment | 1 | 2 | 3 | 4 | 7 | Average |
| Control | 100 | 100 | 100 | 100 | 100 | 100 |
| 25 ppm PBI-429 | 81 | 64 | 69 | 81 | 73 | 74 |
| 25 ppm PBI-429 + 0.05% | 64 | 48 | 52 | 55 | 73 | 58 |
| Capsil | | | | | | |
| 25 ppm PBI-524 | 81 | 63 | 69 | 79 | 91 | 77 |
| 25 ppm PBI-524 + 0.05% | 76 | 58 | 58 | 64 | 84 | 68 |
| Capsil | | | | | | |

### Example 11

The effect of the adjuvant Brij 98 in combination with the nitrogen fertilizer urea on improving ABA analog performance for leaf transpiration inhibition was determined for PBI-429 (Table 11). At 2 and 3 days after treatment, leaf transpiration rate of plants treated with PBI-429 with 0.05% Brij 98 and 10 mM urea was less than plant treated with PBI-429 alone, PBI-429 with 0.05% Brij 98, or PBI-429 with urea. Results indicated that while either adjuvant or nitrogen fertilizer alone improved PBI-429 efficacy, the combination of adjuvant and fertilizer was more effective for improving PBI-429 performance at 2 or 3 days after application.

TABLE 11
Effect of Brij 98, urea and their combination on improving
PBI-429 performance for tomato leaf transpiration inhibition.

| | Transpiration rate | | | |
|---|---|---|---|---|
| | (% of control) | | | |
| | Days after treatment | | | |
| Treatment | 1 | 2 | 3 | Average |
| Control | 100 | 100 | 100 | 100 |
| 25 ppm PBI-429 | 77 | 60 | 71 | 70 |
| 25 ppm PBI-429 + 0.05% Brij 98 | 56 | 43 | 53 | 51 |
| 25 ppm PBI-429 + 10 mM urea | 84 | 55 | 61 | 67 |
| 25 ppm PBI-429 + 0.05% Brij 98 + | 55 | 37 | 45 | 46 |
| 10 mM urea | | | | |

1. An agricultural composition comprising an agriculturally effective amount of an ABA analog or its salts and a surfactant.

2. The composition of claim 1 that further comprises a fertilizer.

3. The composition of claim 1 wherein the surfactant is of the polyoxyethylene fatty alcohol ether surfactant family.

4. The composition of claim 3 wherein the surfactant is Brij 98.

5. The composition of claim 1 wherein the surfactant is of the nonylphenol ethoxylate family.

6. The composition of claim 5 wherein the surfactant is Agral 90.

7. The composition of claim 1 wherein the surfactant is of the polyalkylene oxide family.

8. The composition of claim 7 wherein the surfactant is Silwet L-77, Kinetic or Capsil.

9. The composition of claim 2 wherein the fertilizer is a nitrogen-containing fertilizer selected from the group consisting of urea, ammonium nitrate and ammonium sulfate.

10. The composition in claim 2 wherein the fertilizer is urea.

11. A method for enhancing and extending the effect of an ABA analog or its salts on plants by applying the composition of claim 1 to plants.

12. The method of claim 11 wherein the surfactant is selected from the group consisting of Brij 98, Agral 90, Silwet L-77, Kinetic and Capsil.

13. The method of claim 11 that further comprises applying a fertilizer to said plants.

14. The method of claim 13 wherein the fertilizer is urea.

15. The method of claim 11 wherein the S-(+)-abscisic acid analog is PBI-429, PBI-524, PBI-696, or PBI-702.
